(19) United States
(12) Patent Application Publication
(10) Pub. No.: US 2022/0008959 A1
(43) Pub. Date: Jan. 13, 2022

(54) OPTICAL SORTER

(71) Applicant: SATAKE CORPORATION, Chiyoda-ku, Tokyo (JP)

(72) Inventors: Tomoyuki MIYAMOTO, Chiyoda-ku, Tokyo (JP); Takuya NISHIDA, Chiyoda-ku, Tokyo (JP)

(73) Assignee: SATAKE CORPORATION, Chiyoda-ku, Tokyo (JP)

(21) Appl. No.: 17/295,526

(22) PCT Filed: Nov. 11, 2019
(86) PCT No.: PCT/JP2019/044066

§ 371 Date: May 20, 2021

(30) Foreign Application Priority Data
Dec. 6, 2018 (JP) 2018-229439

(51) Int. Cl. B07C 5/342; B07C 5/36

(52) U.S. Cl. CPC B07C 5/3425; B07C 5/366

(57) ABSTRACT

An optical sorter includes optical sorting units adapted to sort materials by quality. A first optical sorting unit sorts the materials by quality and transfers a fraction of the materials discharged from a defectives discharge unit in the first optical sorting unit to a second optical sorting unit. A second optical sorting unit sorts the materials by quality and transfers a fraction of the materials discharged from a defectives discharge unit in the second optical sorting unit to a third optical sorting unit, which sorts the materials transferred from the second optical sorting unit by quality. The optical sorter allows a fraction of the materials to be transferred to the third optical sorting unit and sorted therein, the materials to be sorted being among the materials sorted by quality in the first optical sorting unit and being discharged from the defectives discharge unit of the first optical sorting unit.

### TECHNICAL FIELD

The present invention relates to an optical sorter that sorts granular matters such as grains or resin pellets based on colors or the like.

### BACKGROUND ART

Conventionally, optical sorters have been known that sort materials into non-defectives and defectives based on colors or the like, or remove foreign matters mixed in the materials based on colors or the like, where examples of the materials include grains such as rice, wheat, beans, and nuts; resin pieces such as pellets and beads; medical products; ores; small items such as young sardines; and other granular matters.

This type of optical sorter emits light to granular matters falling from an end of a transport route along a predetermined trajectory, receives reflected light and the like from the granular matters, thereby detects defectives and foreign matters contained in the materials, removes the detected defectives and foreign matters by a jet of air and the like, and thereby sorts the granular matters.

Now, it is known that to improve a collection rate of non-defectives, the known optical sorter has a plurality of sorting units arranged side by side and sorts feedstock or materials of granular matters into non-defectives and defectives in plural stages (see, for example, Patent Literatures 1 and 2).

FIG. 7 is an explanatory diagram of procedures for sorting granular matters according to good/bad quality using three sorting units arranged side by side in an optical sorter described in Patent Literature 1.

In the optical sorter shown in FIG. 7, granular matters supplied from outside of the sorter as the feedstock are sorted into non-defectives and defectives in a primary sorting unit. The granular matters sorted into defectives in the primary sorting unit are transferred to a secondary sorting unit and then sorted there into non-defectives and defectives. The granular matters sorted into defectives in the secondary sorting unit are transferred to a tertiary sorting unit and then sorted there into non-defectives and defectives.

On the other hand, the granular matters sorted into non-defectives in the secondary sorting unit are transferred to the primary sorting unit again and sorted into non-defectives and defectives in the primary sorting unit. The granular matters sorted into non-defectives in the tertiary sorting unit are transferred to the secondary sorting unit again and sorted into non-defectives and defectives in the secondary sorting unit.

Then, granular matters sorted into non-defectives in the primary sorting unit are discharged out of the optical sorter as non-defectives. The granular matters sorted into defectives in the tertiary sorting unit are discharged out of the optical sorter as defectives.

In the optical sorter shown in FIG. 7, non-defectives mixed in defectives by being involved in air for blowing off the defectives or the like in the primary sorting unit can be collected and thus the collection rate of non-defectives can be improved.

However, the optical sorter shown in FIG. 7 has a problem in that if too much granular matters are sorted as defectives in the primary sorting unit, the granular matters transferred to the secondary sorting unit are also too much so it lead to the overloading of the secondary sorting unit and the sorting capacity and thus the operating efficiency should be reduced.

FIG. 8 is an explanatory diagram of procedures of an optical sorter described in Patent Literature 2 using three sorting units arranged side by side for sorting granular matters according to good/bad quality.

The optical sorter shown in FIG. 8 is that obtained by retrofitting each sorting units of the optical sorter shown in FIG. 7 such that a roughly-sorted material discharge path is formed in each sorting unit between a non-defectives discharge path and a defectives discharge path so as to discharge granular matters sorted as roughly-sorted materials from the roughly-sorted material discharge path and transfer to the same sorting unit and sorted there into non-defectives and defectives.

In the case of the optical sorter shown in FIG. 8, roughly-sorted materials of significantly high content of non-defectives are transferred to the same primary sorting unit and sorted again into non-defectives and defectives, so that more efficient collection of non-defectives can be expected than that of the optical sorter shown in FIG. 7. Thus the amount of the granular matters transferred to the secondary sorting unit is reduced so that the load to be imposed on the secondary sorting unit can be reduced and the feed rate of the feedstock to the primary sorting unit can also be increased, and thus operating efficiency is improved.

It should be noted in the optical sorter shown in FIG. 8 that it is necessary to assure the quality (i.e. a proportion between non-defectives and defectives) of the roughly-sorted materials is substantially the same as those supplied outboard of the sorter so that it is impossible to open wide an inlet side of the roughly-sorted material discharge path and an amount of the granular matters sorted into the roughly-sorted materials is limited thereby, and thus there is room for further improvement of operating efficiency.

### CITATION LIST

### Patent Literature

[Patent Literature 1]

Japanese Patent Laid-Open No. 2000-107703

[Patent Literature 2]

Japanese Patent Laid-Open No. 2012-217874

### SUMMARY OF INVENTION

### Technical Problem

Thus, an object of the present invention is to provide an optical sorter that can improve operating efficiency.

### Solution to Problem

To achieve the above object, according to a first aspect of the present invention, there is provided an optical sorter comprising three optical sorting units for sorting materials to be sorted according to good/bad quality, each of the optical sorting units including: optical detection means for detecting the materials to be sorted falling along a predetermined trajectory; ejection means for removing defectives from the materials to be sorted falling along the predetermined trajectory based on detection results obtained in the optical detection means; and discharge means that includes a non-defectives discharge unit arranged at a fall position of the materials to be sorted falling along the predetermined trajectory and a defectives discharge unit arranged at a fall position of the materials to be sorted and displaced by the ejection means.

The optical sorter sorts the materials to be sorted according to good/bad quality in a first optical sorting unit and transfers thus sorted fraction of the materials to be sorted which is discharged from a defectives discharge unit of the discharge means in the first optical sorting unit to a second optical sorting unit to sort the discharged materials according to good/bad quality, sorts the materials according to good/bad quality in the second optical sorting unit and transfers thus sorted fraction of the materials which is discharged from a defectives discharge unit of discharge means in the second optical sorting unit to a third optical sorting unit to sort the discharged materials according to good/bad quality, and allows a fraction of sorting materials to be transferred to the third optical sorting unit and sorted therein, the materials to be sorted being among the materials to be sorted according to good/bad quality in the first optical sorting unit and being discharged from the defectives discharge unit.

According to a second aspect of the present invention, in the first aspect of the present invention, the discharge means in the first optical sorting unit includes a plurality of defectives discharge paths provided in accordance with the displacement of the materials to be sorted due to the ejection means; and a defectives discharge path arranged closer to the ejection means is designated as a second optical sorting unit discharge path and a defectives discharge path arranged farther from the ejection means than the second optical sorting unit discharge path is designated as a third optical sorting unit discharge path, wherein the materials to be sorted discharged through the second optical sorting unit discharge path are transferred to the second optical sorting unit and sorted therein according to good/bad quality and the materials to be sorted discharged through the third optical sorting unit discharge path are transferred to the third optical sorting unit and sorted therein according to good/bad quality.

According to a third aspect of the present invention, in the second aspect of the present invention, a defectives discharge path arranged between a non-defectives discharge unit of the discharge means in the first optical sorting unit and the second optical sorting unit discharge path by being located adjacent to the non-defectives discharge unit is designated as a first optical sorting unit discharge path, and the materials to be sorted discharged through the first optical sorting unit discharge path are transferred to the first optical sorting unit again and sorted therein according to good/bad quality.

According to a fourth aspect of the present invention, in any one of the first to third aspects of the present invention, the discharge means in the second optical sorting unit includes a plurality of defectives discharge paths provided according to the displacement of the materials to be sorted due to the ejection means; and a defectives discharge path arranged closer to the ejection means is designated as a third optical sorting unit discharge path and a defectives discharge path arranged farther from the ejection means than the third optical sorting unit discharge path is designated as an off-the-machine discharge path, wherein the materials to be sorted discharged through the third optical sorting unit discharge path are transferred to the third optical sorting unit and sorted therein according to good/bad quality and the materials to be sorted discharged from the off-the-machine discharge path are discharged out of the optical sorter.

According to a fifth aspect of the present invention, in the fourth aspect of the present invention, a defectives discharge path arranged between a non-defectives discharge unit of the discharge means in the second optical sorting unit and the third optical sorting unit discharge path by being located adjacent to the non-defectives discharge unit is designated as a second optical sorting unit discharge path, and the materials to be sorted discharged through the second optical sorting unit discharge path are transferred to the second optical sorting unit again and sorted therein according to good/bad quality.

According to a sixth aspect of the present invention, in any one of the first to fifth aspects of the present invention, the discharge means in the third optical sorting unit includes a plurality of defectives discharge paths provided according to the displacement of the materials to be sorted due to the ejection means; and a defectives discharge path arranged adjacent to a non-defectives discharge unit of the discharge means in the third optical sorting unit is designated as a third optical sorting unit discharge path and a defectives discharge path arranged farther from the ejection means than the third optical sorting unit discharge path is designated as an off-the-machine discharge path, and the materials to be sorted discharged through the third optical sorting unit discharge path are transferred to the third optical sorting unit again and sorted therein according to good/bad quality, and the materials to be sorted discharged from the off-the-machine discharge path are discharged out of the optical sorter.

According to a seventh aspect of the present invention, in any one of the first to fifth aspects of the present invention, all the materials to be sorted and discharged from a defectives discharge unit of the discharge means in the third optical sorting unit are discharged out of the optical sorter.

According to an eighth aspect of the present invention, in any one of the first to seventh aspects of the present invention, the materials to be sorted discharged from a non-defectives discharge unit of the discharge means in the first optical sorting unit are discharged out of the optical sorter as non-defectives; the materials to be sorted discharged from a non-defectives discharge unit of the discharge means in the second optical sorting unit are transferred to the first optical sorting unit again and sorted therein according to good/bad quality; and the materials to be sorted discharged from a non-defectives discharge unit of discharge means in the third optical sorting unit are transferred to the first or second optical sorting unit again and sorted therein according to good/bad quality.

According to a ninth aspect of the present invention, in any one of the first to seventh aspects of the present invention, the materials to be sorted discharged from a non-defectives discharge unit of the discharge means in the first optical sorting unit are discharged out of the optical sorter as non-defectives; the materials to be sorted discharged from a non-defectives discharge unit of the discharge means in the second optical sorting unit are discharged out of the optical sorter as non-defectives; and the materials to be sorted discharged from a non-defectives discharge unit of discharge means in the third optical sorting unit are discharged out of the optical sorter as non-defectives.

Here, in the description of the aspects of the present invention, “the sorting according to good/bad quality” in the optical sorting units is not limited to the sorting of feedstock into non-defectives and defectives, and includes the sorting of the feedstock to remove foreign matters mixed therein as well as the sorting of the feedstock in accordance with the types of the material included in the feedstock. In that case, the “non-defectives” and “defectives” obtained by sorting the feedstock according to the present invention can read “materials taken out by sorting” and “foreign matters” when sorting the feedstock to remove foreign matters mixed therein, and a “specific material” and “the other materials” when sorting the feedstock in accordance with the types of the material included in the feedstock.

Besides, the optical sorter according to any one of the aspects of the present invention can also remove non-defectives using the ejection means. In that case, the “non-defectives” of materials according to the present invention can read “defectives,” and the “defectives” can read “non-defectives.”

### Advantageous Effects of Invention

Since the optical sorter according to aspect 1 of the present invention may include three or more optical sorting units, which not only to sort the materials to be sorted according to good/bad quality in the first optical sorting unit and transfer the materials to be sorted discharged from the defectives discharge unit of the discharge means in the first optical sorting unit to the second optical sorting unit to sort further the discharged sorted materials according to good/bad quality, but also allows a fraction of the sorted materials to be transferred to the third optical sorting unit and sorted therein according to good/bad quality, the sorted materials transferred to the second optical sorting unit are reduced greatly. This makes it possible to greatly increase the material to be supply to the first optical sorting unit while reducing the load to be imposed on the second optical sorting unit greatly.

Thus, the optical sorter according to aspect 1 of the present invention can improve operating efficiency.

The optical sorter according to aspect 2 of the present invention includes a plurality of defectives discharge paths provided on each of which the defectives discharge unit is arranged according to the displacement of the materials to be sorted due to the ejection means, wherein a defectives discharge path arranged closer to the ejection means is designated as a second optical sorting unit discharge path and a defectives discharge path arranged farther from the ejection means than the second optical sorting unit discharge path is designated as a third optical sorting unit discharge path.

In the materials to be sorted displaced by the ejection means, the further it is displaced from the ejection means, the higher the proportion of defectives and the lesser the proportion of non-defectives. Therefore, with the optical sorter according to the present invention described in claim 2, of the sorting materials sorted into defectives, a fraction of sorted materials higher in its content of non-defectives is transferred to the second optical sorting unit and sorted therein according to good/bad quality, and a fraction of sorted materials lower in its content of non-defectives is transferred to the third optical sorting unit and sorted therein according to good/bad quality.

Thus, the optical sorter according to aspect 2 of the present invention can further improve operating efficiency.

With the optical sorter according to aspect 3 of the present invention, since a defectives discharge path arranged between a non-defectives discharge unit of the discharge means in the first optical sorting unit and the second optical sorting unit discharge path by being located adjacent to the non-defectives discharge unit is designated as a first optical sorting unit discharge path, a fraction of the sorted materials of a significantly high content of non-defectives of the materials sorted into defectives is transferred to the first optical sorting unit again and sorted therein according to good/bad quality.

Thus, the optical sorter according to aspect 3 of the present invention can further improve operating efficiency.

In the optical sorter according to aspect 4 of the present invention, since the defectives discharge unit of the discharge means in the second optical sorting unit includes a plurality of defectives discharge paths arranged according to the displacement of the materials to be sorted due to the ejection means and a defectives discharge path arranged closer to the ejection means is designated as a third optical sorting unit discharge path while a defectives discharge path arranged farther from the ejection means than the third optical sorting unit discharge path is designated as an off-the-machine discharge path, a fraction of the sorted materials relatively higher in the content of non-defectives is transferred to the third optical sorting unit and sorted therein according to good/bad quality while the fraction relatively lower in the content of non-defectives is discharged out of the optical sorter.

Thus, the optical sorter according to aspect 4 of the present invention can further improve operating efficiency.

In the optical sorter according to aspect 5 of the present invention, since a defectives discharge path arranged between a non-defectives discharge unit of the discharge means in the second optical sorting unit and the third optical sorting unit discharge path by being located adjacent to the non-defectives discharge unit is designated as a second optical sorting unit discharge path, the materials to be sorted with a relatively high content of non-defectives are transferred to the second optical sorting unit again and sorted therein according to good/bad quality.

Thus, the optical sorter according to aspect 5 of the present invention can further improve operating efficiency.

In the optical sorter according to aspect 6 of the present invention, since the defectives discharge unit of the discharge means in the third optical sorting unit includes a plurality of defectives discharge paths arranged according to the displacement of the materials to be sorted due to the ejection means and a defectives discharge path arranged adjacent to a non-defectives discharge unit of the discharge means in the third optical sorting unit is designated as a third optical sorting unit discharge path while a defectives discharge path arranged farther from the ejection means than the third optical sorting unit discharge path is designated as an off-the-machine discharge path, the materials to be sorted of relatively high content of non-defectives are transferred to the third optical sorting unit again and sorted therein according to good/bad quality and the materials to be sorted of low content of non-defectives are discharged out of the optical sorter.

Thus, the optical sorter according to aspect 6 of the present invention can further improve operating efficiency.

In the optical sorter according to aspect 9 of the present invention, the materials to be sorted discharged from a non-defectives discharge unit of the discharge means in the first optical sorting unit are discharged out of the optical sorter as non-defectives, the materials to be sorted discharged from a non-defectives discharge unit of the discharge means in the second optical sorting unit are discharged out of the optical sorter as non-defectives, and the materials to be sorted discharged from a non-defectives discharge unit of discharge means in the third optical sorting unit are discharged out of the optical sorter as non-defectives. This makes it possible to further improve operating efficiency.

### BRIEF DESCRIPTION OF DRAWINGS

FIG. 1 is a sectional side view showing an internal structure of an optical sorter.

FIG. 2 is an explanatory diagram of how sorting is done by an optical sorter according to Embodiment 1 of the present invention.

FIG. 3 is an explanatory diagram of sorting procedures carried out by the optical sorter according to Embodiment 1 of the present invention.

FIG. 4 is an explanatory diagram of how sorting is done by an optical sorter according to Embodiment 2 of the present invention.

FIG. 5 is an explanatory diagram of sorting procedures carried out by the optical sorter according to Embodiment 2 of the present invention.

FIG. 6 is an explanatory diagram of sorting procedures carried out by an optical sorter according to Embodiment 3 of the present invention.

FIG. 7 is an explanatory diagram of sorting procedures carried out by a conventional optical sorter.

FIG. 8 is an explanatory diagram of sorting procedures carried out by a conventional optical sorter.

### DESCRIPTION OF EMBODIMENTS

Embodiments of the present invention will now be described with reference to the accompanying drawings.

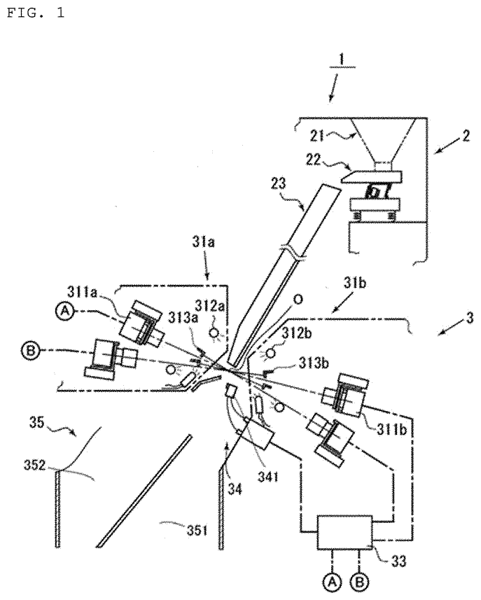

FIG. 1 is a sectional side view showing an internal structure of an exemplary optical sorter in a simplified manner.

The optical sorter shown in FIG. 1 includes a feedstock or granular matter supply unit 2 and an optical sorting unit 3.

The granular matter supply unit 2 includes a feed stock tank 21, a vibratory feeder 22 for delivering out the granular matter in the feedstock tank 21, and an inclined chute 23 of a predetermined width for allowing the granular matter delivered from the vibratory feeder 22 to flow down.

The vibratory feeder 22 is placed on a vibration generator having a vibrator or the like and configured to control an amount of the granular matters to be supplied to the inclined chute 23 by regulating the frequency and/or the amplitude of the vibration generated.

The optical sorting unit 3 includes a pair of optical detectors 31a and 31b disposed in front of and behind a fall trajectory of granular matters, a discriminator 33 adapted to discriminate the granular matters as non-defectives or defectives based on the signals from the optical detectors 31a and 31b, an ejector 34 adapted to eject the defectives based on the discrimination results of the discriminator 33 to sort the granular matters into non-defectives and defectives, and a discharge hopper 35 adapted to discharge the granular matters sorted into non-defectives and defectives by the ejector 34.

The optical detectors 31a and 31b are suitable for addressing granular matters released into the air and spreaded in a width direction from a lower end of the inclined chute 23. The optical detectors 31a and 31b has built-in line sensors or area sensors such as CCDs. Particularly the detectors include imaging means 311a and 311b such as CCD cameras capable of receiving light in NIR (near-infrared), visible, ultraviolet, or other wavelength region, illumination means 312a and 312b such as fluorescent lamps, halogen lamps, LED light sources adapted to illuminate a detection position O of the granular matter on a predetermined fall trajectory, and backgrounds 313a and 313b.

The optical detectors 31a and 31b image the granular matters against the backgrounds 313a and 313b at the detection position O using the imaging means 311a and 311b, respectively.

The discriminator 33 includes threshold setting means for setting a threshold for distinguishing between non-defectives and defectives in granular matters, and discrimination means for discriminating the granular matters as non-defectives or defectives based on the threshold. The threshold can be set as a signal level value of a light amount or a light component in an imaging signal of the granular matters imaged by the imaging means 311a and 311b.

Then, based on the imaging signal of the granular matters sent from the optical detectors 31a and 31b, the discriminator 33 discriminates the granular matters as non-defectives and defectives.

The ejector 34, which are suitable for addressing granular matters released into the air and spreaded in a width direction from a lower end of the inclined chute 23 as with the optical detectors 31a and 31b, includes a nozzle 341 capable of selectively ejecting air through a plurality of nozzle holes formed and aligned in the width direction.

Based on a defectives removal signal sent from the discriminator 33, the ejector 34 blows air out through a predetermined nozzle hole in a predetermined timing and to remove
the defectives from a predetermined fall trajectory.

The discharge hopper 35 includes a non-defectives discharge unit 351 adapted to discharge non-defectives falling along the predetermined fall trajectory and a defectives discharge unit 352 adapted to discharge defectives falling along a changed fall trajectory by being displaced by the ejector 34.

The granular matters displaced by the ejector 34 are discharged from the defectives discharge unit 352 of the discharge hopper 35 while the granular matters not displaced by the ejector 34 are discharged from the non-defectives discharge unit 351 of the discharge hopper 35, and consequently the granular matters are sorted into non-defectives and defectives.

### Embodiment 1

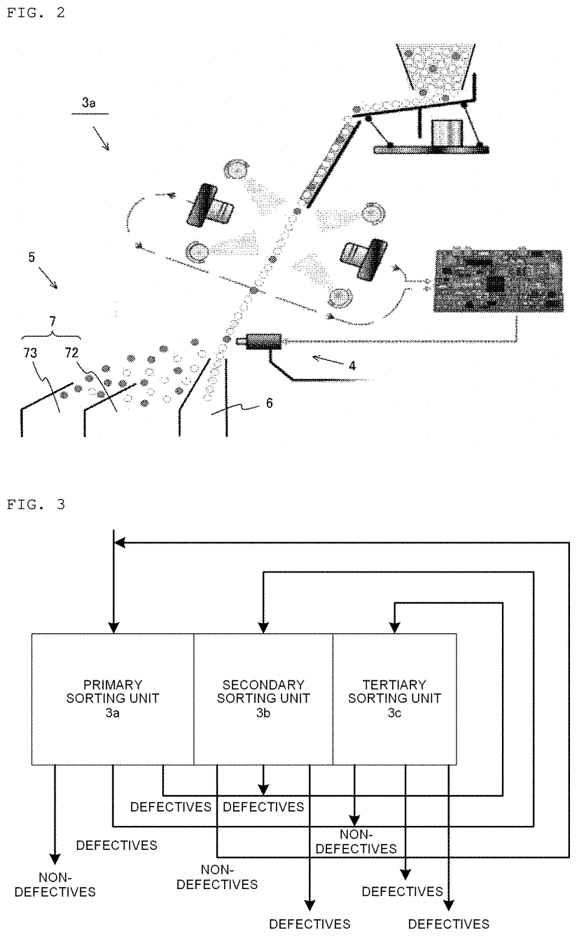

FIG. 2 is an explanatory diagram of how sorting is to be done by a primary sorting unit 3a of an optical sorter according to Embodiment 1 of the present invention and FIG. 3 is an explanatory diagram of sorting procedures carried out by the optical sorter of FIG. 2.

The optical sorter according to Embodiment 1 of the present invention includes three optical sorting units 3a to 3c and it is adapted to sort granular matters or feedstock into non-defectives and defectives in three stages.

In the optical sorter according to Embodiment 1 of the present invention, a defectives discharge unit 7 of a discharge hopper 5 of each of the optical sorting units 3a to 3c includes two defectives discharge paths arranged according to the displacement of the granular matters removed by the ejector 4.

In the discharge hopper 5 of the primary sorting unit 3a, a defectives discharge path arranged closer to the ejector 4 is designated as a secondary sorting unit discharge path 72 and a defectives discharge path arranged farther from the ejector 4 than the secondary sorting unit discharge path 72 is designated as a tertiary sorting unit discharge path 73.

In a discharge hopper of a secondary sorting unit 3b, a defectives discharge path arranged closer to the ejector is designated as a tertiary sorting unit discharge path and a defectives discharge path arranged farther from the ejector than the tertiary sorting unit discharge path is designated as an off-the-machine discharge path.

In a discharge hopper of a tertiary sorting unit 3c, both a defectives discharge path arranged on the side closer to the ejector and a defectives discharge path arranged farther from the ejector are designated as off-the-machine discharge paths.

In the optical sorter according to Embodiment 1 of the present invention, the granular matters sorted according to good/bad quality by the primary sorting unit 3a and discharged through the secondary sorting unit discharge path 72 of the discharge hopper 5 are transferred to the secondary sorting unit 3b by transfer means, and then sorted again according to good/bad quality by the secondary sorting unit 3b. Also, the granular matters discharged through the tertiary sorting unit discharge path 73 are transferred to the tertiary sorting unit 3c by transfer means, and then sorted again according to good/bad quality by the tertiary sorting unit 3c. The granular matter sorted according to good/bad quality by the primary sorting unit 3a and discharged from a non-defectives discharge unit 6 are discharged out of the optical sorter as non-defectives.

The granular matters sorted according to good/bad quality by the secondary sorting unit 3b and discharged through the tertiary sorting unit discharge path of the discharge hopper are transferred to the tertiary sorting unit 3c by transfer means, and then sorted again according to good/bad quality by the tertiary sorting unit 3c. Also, the granular matters discharged through the off-the-machine discharge path are discharged out of the optical sorter as defectives. The granular matters sorted according to good/bad quality by the secondary sorting unit 3b and discharged from the non-defectives discharge unit are transferred again to the primary sorting unit 3a by transfer means and then sorted according to good/bad quality in the primary sorting unit 3a.

The granular matters sorted according to good/bad quality in the tertiary sorting unit 3c and discharged through the off-the-machine discharge path of the discharge hopper are discharged out of the optical sorter as defectives. Also, the granular matters sorted according to good/bad quality in the tertiary sorting unit 3c and discharged from the non-defectives discharge unit are transferred to the secondary sorting unit 3b again by transfer means and then sorted according to good/bad quality in the secondary sorting unit 3b.

Known transfer means such as conveyors or elevators can be used as the transfer means described above.

The optical sorter according to Embodiment 1 of the present invention is configured such that in the primary sorting unit 3a, the defectives discharge unit 7 of the discharge hopper 5 includes two defectives discharge paths arranged according to the displacement of the granular matters removed by an ejector 4. Consequently, the optical sorter can transfer the granular matters discharged from the defectives discharge unit 7 to the tertiary sorting unit 3c as well as to the secondary sorting unit 3b.

The optical sorter according to Embodiment 1 of the present invention can transfer a lot of granular matters from the defectives discharge unit 7 to the tertiary sorting unit 3c. This makes it possible to greatly reduce the granular matters transferred from the primary sorting unit 3a to the secondary sorting unit 3b, resulting in great load reductions on the secondary sorting unit 3b. On the other hand, the granular matters supplied to the primary sorting unit 3a from out of the optical sorter can be increased greatly.

Thus, the optical sorter according to Embodiment 1 of the present invention can improve operating efficiency.

Also, with the optical sorter according to Embodiment 1 of the present invention, the proportion of defectives increases (the content of non-defectives decreases) with increasing distance from the ejector 4 and the proportion of defectives decreases (the content of non-defectives increases) with decreasing distance from the ejector 4. In the discharge hopper 5 of the primary sorting unit 3a, a defectives discharge path arranged on the side closer to the ejector 4 is designated as a secondary sorting unit discharge path 72 and a defectives discharge path arranged on the side farther from the ejector 4 than the secondary sorting unit discharge path 72 is designated as a tertiary sorting unit discharge path 73. Consequently, of the granular matters sorted according to good/bad quality by the primary sorting unit 3a and removed by the ejector 4, granular matters with a relatively high content of non-defectives can be transferred to the secondary sorting unit 3b and granular matters with a relatively low content of non-defectives can be transferred to the tertiary sorting unit 3c.

Thus, the optical sorter according to Embodiment 1 of the present invention can further improve operating efficiency.

Furthermore, in the optical sorter according to Embodiment 1 of the present invention, regarding the discharge hopper of the secondary sorting unit 3b, a defectives discharge path arranged on the side closer to the ejector is designated as a tertiary sorting unit discharge path and a defectives discharge path arranged on the side farther from the ejector than the tertiary sorting unit discharge path is designated as an off-the-machine discharge path. Consequently, of the granular matters sorted according to good/bad quality in the secondary sorting unit 3b and removed by the ejector, granular matters with a relatively high content of non-defectives can be transferred to the tertiary sorting unit 3c and sorted materials with a low content of non-defectives can be discharged out of the optical sorter as defectives without being transferred to the tertiary sorting unit 3c.

Thus, the optical sorter according to Embodiment 1 of the present invention can further improve operating efficiency.

Although it has been stated herein that the optical sorter according to Embodiment 1 of the present invention is configured such that in the primary sorting unit 3a, the defectives discharge unit 7 of the discharge hopper 5 includes two defectives discharge paths arranged according to the displacement of the granular matters removed by the ejector 4, the defectives discharge unit 7 may include a single defectives discharge path.

In that case, in connection with the granular matters sorted according to good/bad quality by the primary sorting unit 3a, either of the following configurations may be used: a configuration in which a transport route of the granular matters discharged from the defectives discharge unit 7 of the discharge hopper 5 can be switched to either of the secondary sorting unit 3b or the tertiary sorting unit 3c and a configuration in which the transport route is branched to both of the secondary sorting unit 3b and the tertiary sorting unit 3c. These configurations make it possible to transfer the granular matters discharged from the defectives discharge unit 7 to the tertiary sorting unit 3c as well as to the secondary sorting unit 3b.

Although it has been stated that the optical sorter according to Embodiment 1, of the present invention is configured such that in the secondary sorting unit 3b, a defectives discharge path arranged on the side closer to the ejector of the discharge hopper is designated as a tertiary sorting unit discharge path and a defectives discharge path arranged on the side farther from the ejector than the tertiary sorting unit discharge path is designated as an off-the-machine discharge path, the defectives discharge path arranged on the side farther from the ejector may also be designated as a tertiary sorting unit discharge path.

Also, although it has been stated that in the secondary sorting unit 3b, the defectives discharge unit of the discharge hopper includes two defectives discharge paths arranged according to the displacement of the granular matters removed by the ejector, by providing the defectives discharge unit with a single defectives discharge path, all the granular matters discharged from the defectives discharge unit may be transferred to the tertiary sorting unit 3c through the single defectives discharge path.

Although it has been stated that the optical sorter according to Embodiment 1 of the present invention is configured such that, in the tertiary sorting unit 3c, the defectives discharge unit of the discharge hopper includes two off-the-machine discharge paths, by providing the defectives discharge unit with a single off-the-machine discharge path, all the granular matters discharged from the defectives discharge unit may be discharged out of the optical sorter through the single defectives discharge path.

Although it has been stated that the optical sorter according to Embodiment 1 of the present invention is configured such that the granular matters sorted according to good/bad quality in the tertiary sorting unit 3c and discharged from the non-defectives discharge unit are transferred to the secondary sorting unit 3b again and sorted therein according to good/bad quality, the granular matters may be sorted according to good/bad quality by being transferred to the primary sorting unit 3a.

Although it has been stated that the optical sorter according to Embodiment 1 of the present invention is configured such that the granular matters discharged from the non-defectives discharge unit of the secondary sorting unit 3b are transferred to the primary sorting unit 3a again and sorted therein according to good/bad quality, the granular matters may be discharged out of the optical sorter as non-defectives. Also, although the granular matters discharged from the non-defectives discharge unit 6 of the tertiary sorting unit 3c are transferred to the secondary sorting unit 3b again and sorted therein according to good/bad quality, the granular matters may be discharged out of the optical sorter as non-defectives. In the secondary sorting unit 3b and the tertiary sorting unit 3c, if the granular matters discharged from the non-defectives discharge units 6 are discharged out of the optical sorter as non-defectives, the operating efficiency can be further improved.

According to Embodiment 1 of the present invention, in the discharge hopper 5, non-illustrated adjustment plate or plates are provided on a top of a partition member between the non-defectives discharge unit 6 and the defectives discharge unit 7 or on tops of partition members dividing the defectives discharge unit 7 into plural defectives discharge paths. The angle of the adjustment plate can be varied relative to the partition member manually or automatically to adjust the amounts of granular matters discharged through the respective discharge paths.

Note that the optical sorter according to Embodiment 1 of the present invention may include three optical sorting units arranged side by side in a single unit of the optical sorter or three independent optical sorters are coupled with each other to allow granular matters or feedstock to be sorted into non-defectives and defectives in three stages.

Also, the optical sorter according to Embodiment 1 of the present invention may include four or more optical sorting units side by side or four or more independent units of the optical sorter can be coupled with each other to allow granular matters or feedstock to be sorted into non-defectives and defectives in four or more stages.

### Embodiment 2

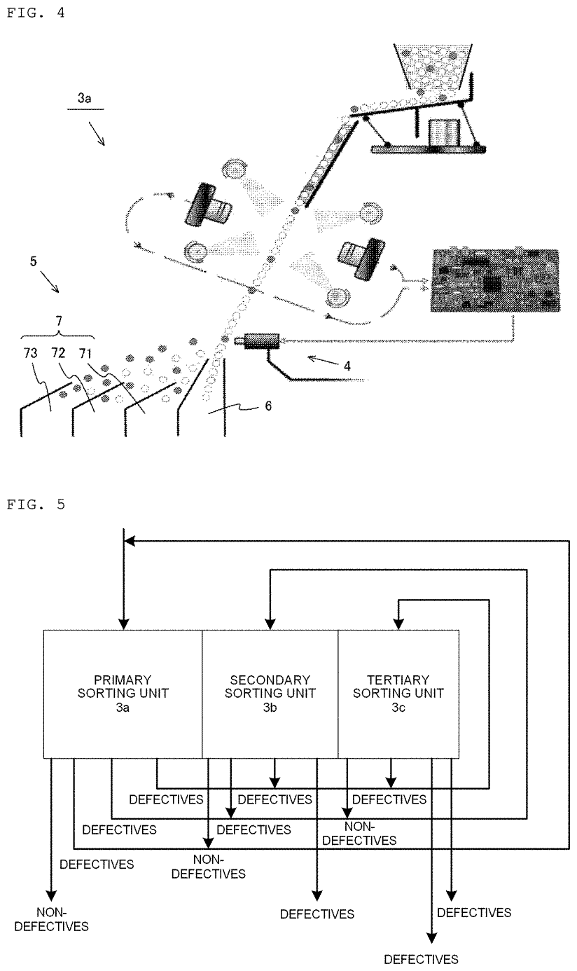

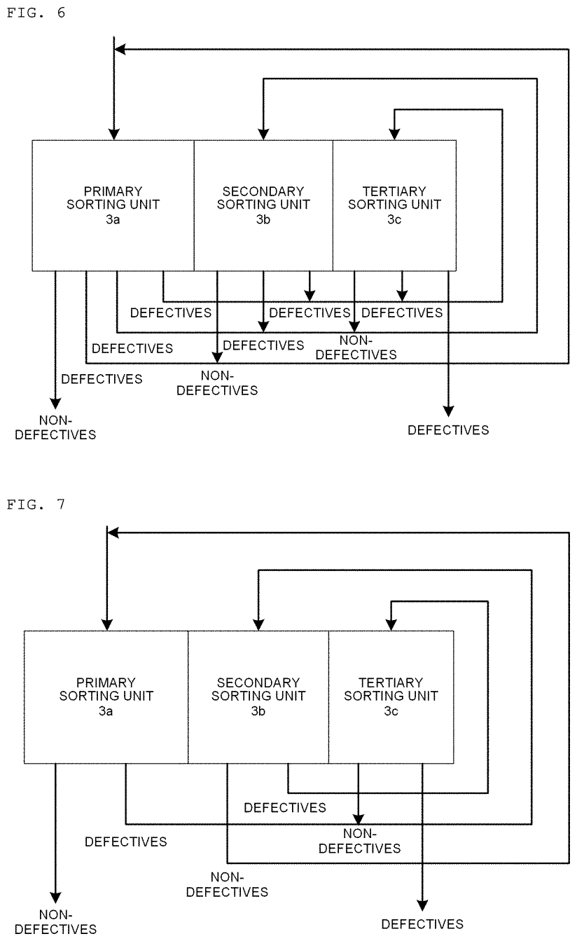

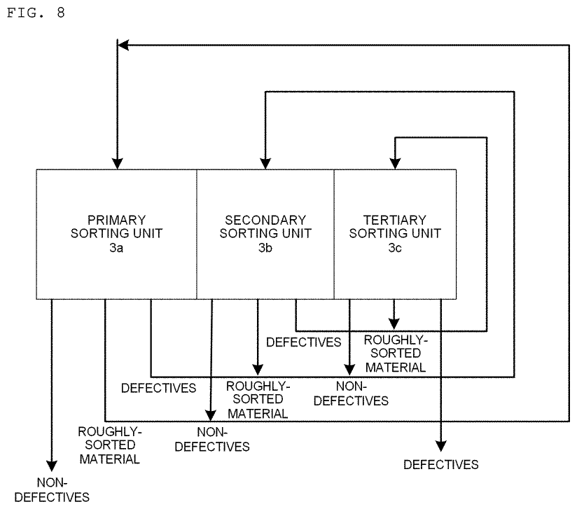

FIG. 4 is an explanatory diagram of how sorting is done by a primary sorting unit 3a of an optical sorter according to Embodiment 2 of the present invention and FIG. 5 is an explanatory diagram of sorting procedures carried out by the optical sorter of FIG. 4.

The optical sorter according to Embodiment 2 of the present invention is provided in each of the defectives discharge units of the respective discharge hoppers in the optical sorter according to Embodiment 1 described above with a third new defectives discharge path arranged adjacent to a non-defectives discharge unit.

In the discharge hopper 5 of the primary sorting unit 3a, as with the primary sorting unit 3a of the optical sorter according to Embodiment 1 described above, a defectives discharge path arranged on the side closer to the ejector 4 is designated as a secondary sorting unit discharge path 72 and a defectives discharge path arranged on the side farther from the ejector 4 than the secondary sorting unit discharge path 72 is designated as a tertiary sorting unit discharge path 73. Also, a new defectives discharge path arranged between the non-defectives discharge unit 6 and the secondary sorting unit discharge path 72 by being located adjacent to the non-defectives discharge unit 6 is designated as a primary sorting unit discharge path 71.

In the discharge hopper of the secondary sorting unit 3b, as with the secondary sorting unit 3b of the optical sorter according to Embodiment 1 described above, a defectives discharge path arranged on the side closer to the ejector is designated as a tertiary sorting unit discharge path and a defectives discharge path arranged on the side farther from the ejector than the tertiary sorting unit discharge path is designated as an off-the-machine discharge path. Also, a new defectives discharge path arranged between the non-defectives discharge unit and the tertiary sorting unit discharge path by being located adjacent to a non-defectives discharge unit is designated as a secondary sorting unit discharge path.

In the discharge hopper of a tertiary sorting unit 3c, as with the tertiary sorting unit 3c of the optical sorter according to Embodiment 1 described above, both a defectives discharge path arranged on the side closer to the ejector and a defectives discharge path arranged on the side farther from the ejector are designated as off-the-machine discharge paths. Also, a new defectives discharge path arranged between the non-defectives discharge unit and the off-the-machine discharge path on the side closer to the ejector by being located adjacent to a non-defectives discharge unit is designated as a tertiary sorting unit discharge path.

The optical sorter according to Embodiment 2 of the present invention can improve operating efficiency as with the optical sorter according to Embodiment 1 described above.

In the optical sorter according to Embodiment 2 of the present invention, the granular matters sorted according to good/bad quality in the primary sorting unit 3a and discharged through the primary sorting unit discharge path 71 are transferred to the primary sorting unit 3a again and then sorted according to good/bad quality in the primary sorting unit 3a.

Also the granular matters sorted according to good/bad quality in the secondary sorting unit 3b and discharged through the secondary sorting unit discharge path are transferred to the secondary sorting unit 3b again and then sorted according to good/bad quality in the secondary sorting unit 3b.

Furthermore, the granular matters sorted according to good/bad quality in the tertiary sorting unit 3c and discharged through the tertiary sorting unit discharge path are transferred to the tertiary sorting unit 3c again and then sorted according to good/bad quality in the tertiary sorting unit 3c.

In the optical sorter according to Embodiment 2 of the present invention, of the granular matters sorted according to good/bad quality in the primary sorting unit 3a, the granular matters with a significantly high content of the non-defectives discharged through the primary sorting unit discharge path 71 are transferred to the same primary sorting unit 3b and sorted therein again, making it possible to efficiently collect non-defectives.

Also, in the optical sorter according to Embodiment 2 of the present invention, of the granular matters sorted according to good/bad quality in the primary sorting unit 3a, the granular matters discharged from the defectives discharge unit 7 of the discharge hopper 5 can be transferred to the primary sorting unit 3a as well as to the secondary sorting unit 3b and the tertiary sorting unit 3c as with the optical sorter according to Embodiment 1 described above. Consequently, the optical sorter according to Embodiment 2 of the present invention can further reduce the load on the secondary sorting unit 3b while greatly increasing the granular matters supplied to the primary sorting unit 3a from out of the optical sorter.

Thus, the optical sorter according to Embodiment 2 of the present invention can further improve operating efficiency.

Note that in the optical sorter according to Embodiment 2 of the present invention, a new defectives discharge path may be provided at least in the defectives discharge unit of the discharge hopper 5 in the primary sorting unit 3a, and provision of a new defectives discharge path in the secondary sorting unit 3b and/or the tertiary sorting unit 3c is optional.

### Embodiment 3

FIG. 6 shows an explanatory diagram of sorting procedures carried out by an optical sorter according to Embodiment 3 of the present invention.

The optical sorter according to Embodiment 3 of the present invention differs from the optical sorter according to Embodiment 2 in the configuration of the defectives discharge unit in the discharge hoppers of the secondary sorting unit 3b and tertiary sorting unit 3c.

The discharge hopper of the primary sorting unit 3a is similar in its configuration to that of the optical sorter according to Embodiment 2 described above.

The discharge hopper of the secondary sorting unit 3b is similar in its configuration to that of the optical sorter according to Embodiment 2 described above but has no off-the-machine discharge path.

The discharge hopper of the tertiary sorting unit 3c

is similar in its configuration to that of the optical sorter according to Embodiment 2 described above but has only one off-the-machine discharge path.

The optical sorter according to Embodiment 3 of the present invention can also improve operating efficiency as was obtained in the optical sorters according to Embodiment 1 and Embodiment 2 described above.

Having been described the optical sorters according to the above embodiments as those configured to remove defectives by the ejectors, it may also be configured to remove non-defectives. When it is intended to sort granular matters or feedstock into non-defectives and defectives through plurality of stages, improvement of the sorting efficiency can be expected by removing either non-defectives or defectives lower in its content in the feedstock.

The optical sorters according to the above embodiments are explained as those configured to take images of the granular matters released into the air from the lower end of the inclined chute 23 at the detection position O by the imaging means 311a and 311b of the optical detectors 31a and 31b, granular matters to be imaged may be those released into the air from an end of a conveyor placed horizontally.

The optical sorters according to the above embodiments are explained as those configured to displace granular matters from predetermined fall trajectory in a contactless manner using air blowing nozzles of an ejector, the granular matters may also be displaced using an ejector made up for example of mechanical means such as a solenoid actuated leaf spring. Note that in that case, defectives and the like can appropriately be removed through the adjustment of a displacement and/or a speed of the leaf spring.

Whereas the optical sorters according to the above embodiments are explained as those sorting granular matters or feedstock into non-defectives and defectives, upon feedstock contamination due to foreign matter is found, it can be used for separating the granular matters of the feedstock and the foreign matters from each other, and provided two or more types of granular matters coexist in the feedstock, one type and the other types of granular matters can be separated from each other. In that case, the non-defectives and the defectives can be referred to as “feedstock” and “foreign matters,” or “one type of granular matters” and “the other types of granular matters.”

Needless to say, the optical sorter according to the present invention is not limited to the above embodiments, and the configuration thereof can be changed as appropriate without departing from the scope of the present invention.

### INDUSTRIAL APPLICABILITY

The optical sorter according to the present invention can make marked improvement over the operating efficiency and thus be extremely useful.

### REFERENCE SIGNS LIST

1 Optical sorter

2 Granular matter supply unit

21 Raw material tank

22 Vibratory feeder

23 Chute

3 Optical sorting unit

31a, 31b Optical detector

311a, 311b Imaging means

312a, 312b Illumination means

313a, 313b Background

33 Discriminator

34 Ejector

35 Discharge hopper

351 Non-defectives discharge path

352 Defectives discharge path

3a Primary sorting unit (first optical sorting unit)

3b Secondary sorting unit (second optical sorting unit)

3c Tertiary sorting unit (third optical sorting unit)

4 Ejector

5 Discharge hopper

6 Non-defectives discharge unit

7 Defectives discharge unit

71 Primary sorting unit discharge path

72 Secondary sorting unit discharge path

73 Tertiary sorting unit discharge path

1. An optical sorter comprising three optical sorting units for sorting materials to be sorted according to good/bad quality, each of the optical sorting units including:
optical detection means for detecting the materials to be sorted falling along a predetermined trajectory;
ejection means for removing defectives from the materials to be sorted falling along the predetermined trajectory based on detection results obtained in the optical detection means; and
discharge means that includes a non-defectives discharge unit arranged at a fall position of the materials to be sorted falling along the predetermined trajectory and a defectives discharge unit arranged at a fall position of the materials to be sorted displaced by the ejection means,
wherein the materials sorted according to good/bad quality in a first optical sorting unit and discharged from a defectives discharge unit of the discharge means in the first optical sorting unit are transferred to a second optical sorting unit and sorted therein according to good/bad quality,
materials to be sorted according to good/bad quality in the second optical sorting unit and discharged from a defectives discharge unit of the discharge means in the second optical sorting unit are transferred to a third optical sorting unit and sorted therein according to good/bad quality, and the optical sorter is characterized in that
a fraction of the materials sorted according to good/bad quality in the first optical sorting unit and discharged from the defectives discharge unit is allowed to be transferred to the third optical sorting unit and sorted therein according to good/bad quality.

2. The optical sorter according to claim 1, wherein the discharge means of the first optical sorting unit includes a plurality of defectives discharge paths provided in accordance with the displacement of the materials to be sorted due to the ejection means; and
a defectives discharge path arranged closer to the ejection means is designated as a second optical sorting unit discharge path and a defectives discharge path arranged farther from the ejection means than the second optical sorting unit discharge path is designated as a third optical sorting unit discharge path, wherein
the materials to be sorted discharged through the second optical sorting unit discharge path are transferred to the second optical sorting unit and sorted therein according to good/bad quality and
the materials to be sorted discharged through the third optical sorting unit discharge path are transferred to the third optical sorting unit and sorted therein according to good/bad quality.

3. The optical sorter according to claim 2, wherein a defectives discharge path arranged between a non-defectives discharge unit of the discharge means in the first optical sorting unit and the second optical sorting unit discharge path by being located adjacent to the non-defectives discharge unit is designated as a first optical sorting unit discharge path, and the materials to be sorted discharged through the first optical sorting unit discharge path are transferred to the first optical sorting unit again and sorted therein according to good/bad quality.

4. The optical sorter according to claim 1, wherein the discharge means in the second optical sorting unit includes a plurality of defectives discharge paths provided according to the displacement of the materials to be sorted due to the ejection means; and
a defectives discharge path arranged closer to the ejection means is designated as a third optical sorting unit discharge path and a defectives discharge path arranged farther from the ejection means than the third optical sorting unit discharge path is designated as an off-the-machine discharge path, wherein
the materials to be sorted discharged through the third optical sorting unit discharge path are transferred to the third optical sorting unit and sorted therein according to good/bad quality and the materials to be sorted discharged from the off-the-machine discharge path are discharged out of the optical sorter.

5. The optical sorter according to claim 4, wherein a defectives discharge path arranged between a non-defectives discharge unit of the discharge means in the second optical sorting unit and the third optical sorting unit discharge path by being located adjacent to the non-defectives discharge unit is designated as a second optical sorting unit discharge path, and the materials to be sorted discharged through the second optical sorting unit discharge path are transferred to the second optical sorting unit again and sorted therein according to good/bad quality.

6. The optical sorter according to claim 1, wherein:
the discharge means in the third optical sorting unit includes a plurality of defectives discharge paths provided according to the displacement of the materials to be sorted due to the ejection means; and
a defectives discharge path arranged adjacent to a non-defectives discharge unit of the discharge means in the third optical sorting unit is designated as a third optical sorting unit discharge path and a defectives discharge path arranged farther from the ejection means than the third optical sorting unit discharge path is designated as an off-the-machine discharge path, and the materials to be sorted discharged through the third optical sorting unit discharge path are transferred to the third optical sorting unit again and sorted therein according to good/bad quality, and the materials to be sorted and discharged from the off-the-machine discharge path are discharged out of the optical sorter.

7. The optical sorter according to claim 1, wherein all the materials to be sorted and discharged from a defectives discharge unit of the discharge means in the third optical sorting unit are discharged out of the optical sorter.

8. The optical sorter according to claim 1, wherein:
the materials to be sorted discharged from a non-defectives discharge unit of the discharge means in the first optical sorting unit are discharged out of the optical sorter as non-defectives;
the materials to be sorted discharged from a non-defectives discharge unit of the discharge means in the second optical sorting unit are transferred to the first optical sorting unit again and sorted therein according to good/bad quality; and
the materials to be sorted discharged from a non-defectives discharge unit of discharge means in the third optical sorting unit are transferred to the first or second optical sorting unit again and sorted therein according to good/bad quality.

9. The optical sorter according to claim 1, wherein:
the materials to be sorted discharged from a non-defectives discharge unit of the discharge means in the first optical sorting unit are discharged out of the optical sorter as non-defectives;
the materials to be sorted discharged from a non-defectives discharge unit of the discharge means in the second optical sorting unit are discharged out of the optical sorter as non-defectives; and
the materials to be sorted discharged from a non-defectives discharge unit of the discharge means in the third optical sorting unit are discharged out of the optical sorter as non-defectives.
